(19) United States
(12) Patent Application Publication
(10) Pub. No.: US 2010/0248576 A1
(43) Pub. Date: Sep. 30, 2010

(54) METHOD FOR PRODUCING PLASMA DISPLAY PANEL

(76) Inventors: Kazuto Fukuda, Osaka (JP); Motoi Hatanaka, Osaka (JP); Michiru Kuromiya, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/730,541

(22) Filed: Mar. 24, 2010

(30) Foreign Application Priority Data
Mar. 25, 2009 (JP) P2009-073610

(51) Int. Cl. H01J 9/00

(52) U.S. Cl. 445/24

(57) ABSTRACT

A method for producing a plasma display panel comprising a front panel wherein an electrode, a dielectric layer and a protective layer are formed on a substrate of the front panel, a formation of the dielectric layer comprising: (i) preparing a dielectric material comprising a glass component and an organic solvent; (ii) supplying the dielectric material onto the substrate having the electrode thereon, and then reducing the organic solvent contained in the supplied dielectric material to form a dielectric precursor layer therefrom; and (iii) heating the dielectric precursor layer to form a dielectric layer therefrom, wherein the content N of the organic solvent contained in the dielectric material of the above (i) satisfies Inequality 1: N<(6.5×Dz+500)/Ez wherein N [% by weight]: content of organic solvent based on the weight of dielectric material Ez [μm]: thickness of electrode provided on substrate of front panel, and Dz [μm]: thickness of dielectric layer of front panel.

### FIELD OF THE INVENTION

The present invention relates to a method for producing a plasma display panel. In particular, the present invention relates to a method for producing a dielectric layer which is provided in a front panel of a plasma display panel.

### BACKGROUND OF THE INVENTION

A plasma display panel (hereinafter also referred to as “PDP”) is suitable for displaying a high-quality television image on a large screen. Thus, there has been an increasing need for various kinds of display devices using the plasma display panel.

The PDP (for example, 3-electrode surface discharge type PDP) comprises a front panel facing the viewer and a rear panel opposed to each other. The front panel and the rear panel are sealed along their peripheries by a sealing material. Between the front panel and the rear panel, there is formed a discharge space filled with a discharge gas (helium, neon or the like).

The front panel is generally provided with a glass substrate, display electrodes (each of which comprises a scan electrode and a sustain electrode), a dielectric layer and a protective layer. Specifically, (i) on one of principal surfaces of the glass substrate, the display electrodes are formed in a form of stripes; (ii) the dielectric layer is formed on the principal surface of the glass substrate so as to cover the display electrodes; and (iii) the protective layer is formed on the dielectric layer so as to protect the dielectric layer.

The rear panel is generally provided with a glass substrate, address electrodes, a dielectric layer, partition walls and phosphor layers (i.e. red, green and blue fluorescent layers). Specifically, (i) on one of principal surfaces of the glass substrate, the address electrodes are formed in a form of stripes; (ii) the dielectric layer is formed on the principal surface of the glass substrate so as to cover the address electrodes; (iii) a plurality of partition walls are formed on the dielectric layer at equal intervals; and (iv) the phosphor layers are formed on the dielectric layer such that each of them is located between the adjacent partition walls.

In the PDP, the display electrode and the address electrode perpendicularly intersect with each other, and such intersection portion serves as a discharge cell. A plurality of discharge cells are arranged in the form of a matrix. Three discharge cells, which have red, green and blue phosphor layers in the arranged direction of the display electrodes, serve as picture elements for color display. In operation of the PDP, ultraviolet rays are generated in the discharge cell upon applying a voltage, and thereby the phosphor layers capable of emitting different visible lights are excited. As a result, the excited phosphor layers respectively emit lights in red, green and blue colors, which will lead to an achievement of a full-color display.

Recently, miniaturization of the discharge cells has been promoted by a demand for a higher definition of the PDP. For example, it is necessary to form the partition walls at 100 μm pitch on the rear panel in order to achieve the higher definition. However, a size reduction of the discharge cells leads to a decrease in emission brightness and thus an increase in power consumption. This is caused by a decrease in an opening ratio, a decrease in light emission time per picture element attributable to an increase in picture element number, a decrease in luminous efficiency or the like. As a method for increasing emission brightness, there has been proposed a method of increasing the opening ratio by decreasing the width of partition walls of the rear panel. However, even in this method, the emission brightness is still insufficient and a further improvement is required.

There has been proposed another method wherein a dielectric constant of a dielectric body in a front panel is decreased, and thereby reducing a reactive power upon discharge so as to improve the luminous efficiency. According to a formation of a front-sided dielectric layer in current method for producing PDPs, a dielectric material which contains glass powder with a size of several μms, an organic binder and a solvent is applied onto a glass plate by a known process such as screen printing process, die coating process or the like. Subsequently, a dielectric layer is formed from the glass material by a drying step, a debindering step (300 to 400° C.) and a calcining step (500 to 600° C.). However, as for current dielectric materials, the glass powder tends to be melted at a low temperature, and thus a “material capable of decreasing a melting point of the glass (e.g. Bi)” is added thereto (see, for example, Japanese Patent Kokai Publication No. 2002-053342). Such material capable of decreasing a melting point of the glass has low purity and has a high dielectric constant of 10 or more. Although the dielectric constant can be decreased by adding other substances (e.g. alkali metal), a highly conductive metal such as silver is used as a main component in an electrode of PDP, and thus a diffusion and colloidization of the silver are promoted due to ion migration, which leads to an yellowing phenomenon in the dielectric body. The yellowing phenomenon has a great adverse influence on the optical characteristics of PDP.

In order to increase emission brightness by decreasing the dielectric constant of the dielectric layer, it is necessary to develop a new low dielectric constant material to replace current types of glass paste, and also develop a method of forming a dielectric layer using such material. As a process for forming a dielectric layer made of high-purity oxide, there has been a process in which a solid oxide is deposited on a substrate by sputtering process under vacuum atmosphere (i.e. sputtering deposition process), and also there has been another process in which a material is deposited by decomposing a raw material with plasma (i.e. chemical vapor deposition process). Although these processes can produce a dielectric layer with a high purity and a low dielectric constant, expensive vacuum facilities are required and a film-forming rate is so low as about several 100 nm per minute. In this regard, for preventing a dielectric breakdown phenomenon upon application of voltage, the required thickness of the dielectric film is usually 10 μm or more and thus the larger number of the equipments are required to increase a productivity thereof.

Alternatively, it has been proposed to melt silica with high purity. However, the melting of such silica is not practical since a high temperature of 1000° C. or higher is required.

As a process for forming a dielectric layer with low dielectric constant while ensuring productivity, there has been proposed a sol-gel process. According to this process, a metal alkoxide is hydrolyzed in a solvent to give a silicon compound and subsequently the silicon compound is subject to a condensation polymerization treatment by heating thereof to form a film which mainly consists of silicon oxide. For example, in a case where the silicon compound is a silicon hydroxide (Si(OH)₄), a network of —Si—O—Si— is formed by the following condensation polymerization reaction and thereby a solid SiO₂ is formed to give a dielectric layer.

nSi(OH)₄→nSiO₂+2nH₂O
(n: an integer of 1 or more)
   In a case where the silicon compound is a siloxane, a dielectric layer is formed by the following condensation polymerization reaction.

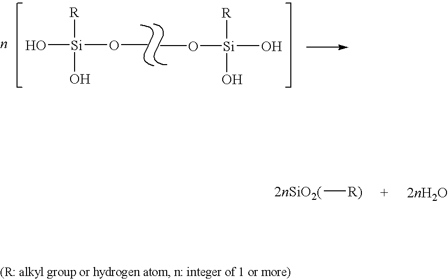

According to the sol-gel process, a dielectric layer can be formed with a low production cost and a short takt time since the existing facilities are available for the application of the raw material paste. Furthermore, according to the sol-gel process, the dielectric layer can be formed at a lower temperature since no melting of the glass is required. However, a cracking phenomenon generally occurs in the dielectric layer as a result of a volume shrinkage thereof attributable to the condensation polymerization reaction (see FIGS. 10 and 11). For this reason, it is generally difficult to form a thick film of the dielectric layer (for example, it is generally difficult to form a dielectric layer with a thickness of about 100 nm).

To cope with the cracking, there has been proposed a method for inhibiting the volume shrinkage by using an acid or base catalyst and a metal alkoxide with an organic functional group such as phenyl group, acryl group or the like (see, for example, Japanese Patent Kokai Publication No. 2005-108691). This method can form a thick dielectric layer. It is however possible in this method that a decomposition of the organic functional group is caused under a high-temperature atmosphere at about 400° C. This means that the cracking phenomenon may occur due to the volume shrinkage and thus it is impossible to form the dielectric layer with a thickness of more than several μms

### SUMMARY OF THE INVENTION

Under the above circumstances, the present invention has been created. Thus, an object of the present invention is to provide a method for producing a PDP, the method being capable of effectively preventing or reducing a cracking phenomenon which may occur upon the formation of the dielectric layer.

Upon due consideration for solving the problems described above, the inventors of the present application noticed a significance of “unevenness” that may occur upon the formation of the dielectric layer. Specifically, the inventors focused attention that the “surface unevenness” or “step” as shown in FIG. 12 may occur when the applied dielectric material paste is dried, such dielectric material paste having been applied on an electrode pattern of the substrate. The occurrence of the unevenness is attributed to the fact that there are an electrode region and a no-electrode region in the substrate surface whereon the dielectric material paste is to be applied (hence the surface unevenness may also be called “Electrode step” or “Unevenness attributable to Electrode”). As shown in FIG. 12, the size Sz of the surface unevenness formed in the dielectric precursor layer is given as Sz=Dz′−Dz where Dz′ is the distance between the substrate surface and the surface of the dielectric precursor layer in the electrode region, Dz is the distance between the substrate surface and the surface of the dielectric precursor layer in the no-electrode region, and Ez is the electrode thickness. By analyzing a stress generated upon the formation of the dielectric layer by means of the finite-element approach, the inventors have found that more stress tends to be generated in the region of the surface unevenness (see FIG. 13(a)). More importantly, it has been found by the inventors that the stress increases so that a cracking phenomenon tends to occur as the size Sz of the surface unevenness becomes larger. See the graph shown in FIG. 13(c).

As a result, the inventors has completed the following invention of a producing method for a PDP, the method being capable of effectively preventing or reducing a cracking phenomenon which may occur in a dielectric layer along the edges of electrodes: The present invention is a method for producing a plasma display panel comprising a front panel wherein an electrode, a dielectric layer and a protective layer are formed on a substrate of the front panel,

a formation of the dielectric layer comprising the steps of:
(i) preparing a dielectric material comprising a glass component and an organic solvent;
(ii) supplying the dielectric material onto the substrate having the electrode thereon, and then reducing the organic solvent contained in the supplied dielectric material to form a dielectric precursor layer therefrom; and
(iii) heating the dielectric precursor layer to form a dielectric layer therefrom,

wherein the content N of the organic solvent contained in the dielectric material which is prepared in the above (i) satisfies Inequality 1.

N<(6.5×Dz+500)/Ez (Inequality 1)
N [% by weight]: Content of organic solvent based on the weight of dielectric material
Ez [μm]: Thickness of electrode provided on substrate of front panel
Dz [μm]: Thickness of dielectric layer of front panel

The method of the present invention is characterized in that the content of the organic solvent contained in the prepared dielectric material is suitably adjusted. Thus, the method of the present invention makes it possible to effectively preventing or reducing a cracking phenomenon (particularly “cracking” along the edges of the electrode) from occurring upon the formation of the dielectric layer.

As used in this specification and claims, the phrase “front panel” refers to a PDP panel disposed on the front side facing the viewer, and thus substantially means a PDP panel disposed on the side where the phosphor layer and partition walls are not provided. In other words, the front panel is a PDP panel disposed to oppose a rear panel whereon the phosphor layer and the partition walls are provided.

In one preferred embodiment, the contained amount of the organic solvent is reduced by heating the supplied dielectric material when the above (ii) is carried out; and

the temperature rising rate T of the dielectric material upon heating thereof satisfies Inequality 2.

T<(16×Dz+410−Ez×N)/(Dz+9) (Inequality 2)
T [° C./min]: Temperature rising rate of the supplied dielectric material upon heating thereof
N [% by weight]: Content of organic solvent based on the weight of dielectric material
Ez [μm]: Thickness of electrode provided on substrate of front panel
Dz [μm]: Thickness of dielectric layer of front panel

In the above embodiment, the temperature rising rate upon forming the dielectric precursor layer is suitably adjusted. Namely, the temperature rising rate of the dielectric material upon heating thereof in order to dry it is suitably adjusted. As a result, it is made possible to more effectively prevent or reducing a cracking phenomenon from occurring in the dielectric layer upon the formation thereof.

In accordance with the method of the present invention, the occurrence of the cracking upon the formation of the dielectric layer can be effectively prevented or reduced. In other words, when the content N of the organic solvent contained in the prepared dielectric material satisfies Inequality 1 and/or the temperature rising rate T of the dielectric material upon heating thereof satisfies Inequality 2, then the occurrence of the surface unevenness of the dielectric precursor layer can be mitigated, and thereby reducing or preventing a stress generated in the dielectric layer, which leads to an effective prevention or reduction of the cracking.

The prevention of the cracking makes it possible to form thicker dielectric layer. And also, the prevention of the cracking gives a prevention of “dielectric breakdown phenomenon” in the dielectric layer upon an application of a higher voltage, which will lead to an achievement of high definition of the plasma display panel. Namely, the plasma display panel provided by the present invention has an improved panel lifetime.

In the method of the present invention, a sol-gel process can be suitably used for forming the dielectric layer since the occurrence of the cracking is avoided during such sol-gel process. The dielectric layer obtained by the sol-gel process can have a desired transmissivity, and a low dielectric constant of 5 or less (at 23° C. and 1 MHz). Accordingly the present invention makes it possible to reduce the value of the dielectric constant of the dielectric layer, and thereby a high efficiency of light emission is achieved, which leads to a PDP with low power consumption. In other words, the producing method of the present invention is very advantageous as it utilizes the sol-gel process that is effective in reducing the dielectric constant, while eliminating or mitigating the disadvantage of using the sol-gel process (i.e. cracking caused by the volume shrinkage during condensation polymerization reaction).

### BRIEF DESCRIPTION OF THE DRAWINGS

FIG. 1 shows a PDP wherein FIG. 1(a) is a perspective view schematically showing a structure of the PDP and FIG. 1(b) is a sectional view schematically showing a structure of the PDP front panel.

FIG. 2 is a perspective view schematically showing the steps in a method of the present invention.

FIG. 3 is a graph showing the dependency of crack occurrence on the thickness of a dielectric layer.

FIG. 4 is a schematic diagram showing “surface unevenness” that may occur in a dielectric precursor layer or a dielectric layer.

FIG. 5 is a graph showing a correlation between “thickness of dielectric layer” and “size of surface unevenness”.

FIG. 6 is a graph showing a rationale for deriving the unevenness size (Ez×N/100) which is associated with Inequalities 1 and 2.

FIG. 7 is a graph showing a relationship between F(Dz) and the thickness of a dielectric layer.

FIG. 8 is a graph showing a correlation between temperature rising rate T, thickness of a dielectric layer and a surface unevenness size Sz.

FIG. 9 is a graph showing a concordance between the values calculated by Inequity 2 and the experimental values shown in FIG. 8.

FIG. 10 is a perspective view schematically showing the cracking that has occurred in the dielectric layer.

FIG. 11 is an electron microscope photograph of the cracking that has occurred in the dielectric layer.

FIG. 12 is a schematic diagram showing “surface unevenness” that has occurred in a dielectric precursor layer or a dielectric layer.

FIG. 13 shows the results (graph and diagram) obtained by analyzing the stress generated upon forming a dielectric layer.

### DESCRIPTION OF REFERENCE NUMERALS

1 . . . Front panel
2 . . . Rear panel (or Back panel)
10 . . . Substrate of front panel
11 . . . Electrode of front panel (Display electrode)
12 . . . Scan electrode
12a . . . Transparent electrode
12b . . . Bus electrode
13 . . . Sustain electrode
13a . . . Transparent electrode
13b . . . Bus electrode
14 . . . Black stripe (light shielding layer)
15 . . . Dielectric layer of front panel
15′ . . . Dielectric material
15″ . . . Dielectric precursor layer
16 . . . Protective layer
20 . . . Substrate of rear panel
21 . . . Electrode of rear panel (Address electrode)
22 . . . Dielectric layer of rear panel
23 . . . Partition wall (Barrier rib)
25 . . . Phosphor layer (fluorescent layer)
30 . . . Discharge space
32 . . . Discharge cell
50 . . . Cracking
100 . . . PDP

### DETAILED DESCRIPTION OF THE PREFERRED EMBODIMENT

With reference to the accompanying drawings, a method for producing a plasma display panel according to the present invention will be described in detail. Various components or elements are shown schematically in the drawings with dimensional proportions and appearances that are not necessarily real, which are merely for the purpose of making it easy to understand the present invention.

### [Construction of Plasma Display Panel]

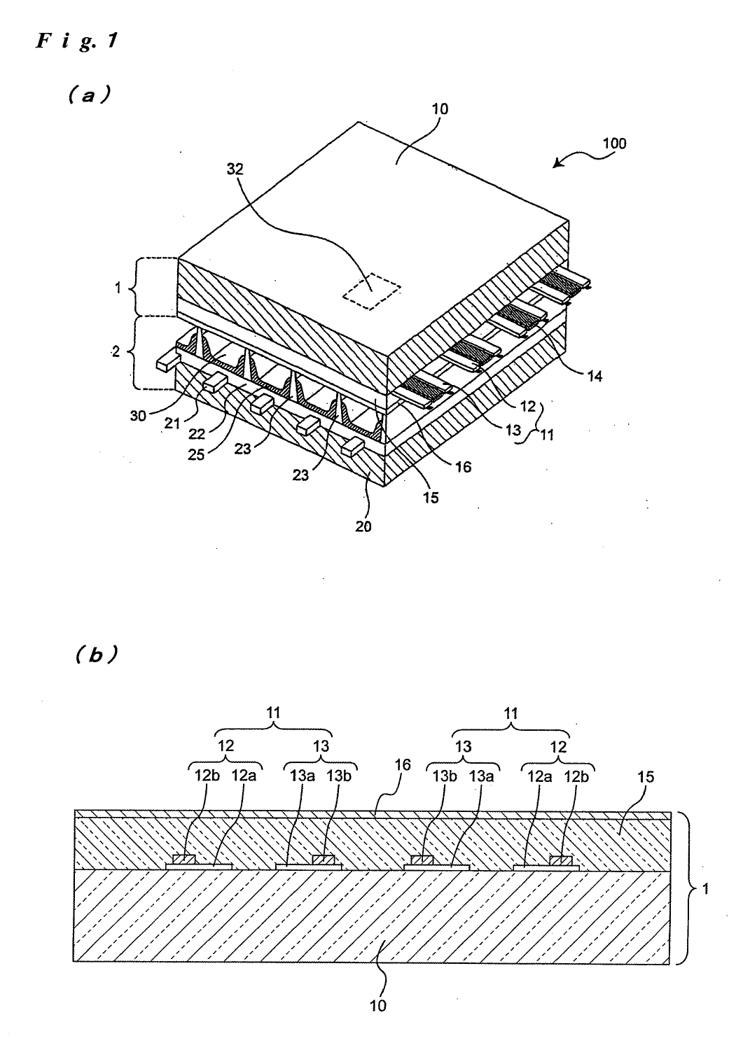

First, a plasma display panel, which can be finally obtained by the method of the present invention, is described below. FIG. 1 (a) schematically shows a perspective and sectional view of the construction of PDP.

In a front panel (1) of PDP (100), a plurality of display electrodes (11) composed of a scan electrode (12) and a sustain electrode (13) are formed on a substrate (10). As the substrate (10), a smooth, transparent and insulating substrate (e.g. glass substrate) may be used. A dielectric layer (15) is formed over the substrate (10) so as to cover the display electrodes (11). A protective layer (16) (for example, protective layer made of MgO) is formed on the dielectric layer (15). Particularly as for the display electrodes (11), each of the scan electrode (12) and the sustain electrode (13) is composed of a transparent electrode (12a, 13a) and a bus electrode (12b, 13b), as shown in FIG. 1(b). The transparent electrode (12a, 13a) may be an electrically conductive transparent film made of indium oxide (ITO) or tin oxide (SnO₂). It is preferred that the thickness of the transparent electrode is in the range of from about 50 nm to about 500 nm. While on the other hand, the bus electrode is a black electrode which mainly consists of silver. It is preferred that the thickness of the bus electrode is in the range of from about 1 μm to about 10 μm. The width of the bus electrode is preferably in the range of from about 10 μm to about 200 μm, and more preferably in the range of from about 50 μm to about 100 μm.

In a rear panel (2) arranged opposed to the front panel (1), a plurality of address electrodes (21) are formed on an insulating substrate (20). A dielectric layer (22) is formed over the substrate (20) so as to cover the address electrodes (21). A plurality of partition walls (23) are disposed on the dielectric layer (22) such that each walls (21) is located between the address electrodes (21). Phosphor layers (25) such as red, green and blue fluorescent layers are formed on a surface of the dielectric layer (22) such that each fluorescent layer is located between adjacent partition walls (23).

The front panel (1) and the rear panel (2) are opposed to each other while interposing the partition walls (23) such that the display electrode (11) and the address electrode (21) perpendicularly intersect with each other. Between the front panel and the rear panel, there is formed a discharged space filled with a discharge gas. As the discharged gas, a noble gas (e.g. helium, neon, argon or xenon) is used. With such a construction of the PDP (100), the discharge space (30) is divided by the partition walls (23). Each of the divided discharge space (30), at which the display electrode (11) and the address electrode (21) intersect with each other, serves as a discharge cell (32).

### [General Method for Production of PDP]

Next, a typical production of the PDP (100) will be briefly described. The typical production of the PDP (100) comprises a step for forming the front panel (1) and a step for forming the rear panel (2).

As for the step for forming the front panel (1), the display electrode (11) is firstly formed on the glass substrate (10). Specifically, a transparent electrode is formed on the glass substrate (10) by a sputtering process, and subsequently a bus electrode is formed on the transparent electrode by a calcining process. Next, a dielectric material is applied over the glass substrate (10) so as to cover the display electrode (11), followed by a heat treatment thereof to form the dielectric layer (15). Next, the protective layer (16) is formed on the dielectric layer (15). Namely, a film made of MgO is provided by an electron-beam evaporation process (i.e. EB evaporation process).

As for the step for forming the rear panel (2), the address electrode (21) is firstly formed on the glass substrate (20) by a calcining process. Next, a dielectric material is applied over the glass substrate (20) so as to cover the address electrode (20), followed by a heat treatment thereof to form the dielectric layer (22). Subsequently, the partition walls (23) made of a low-melting point glass are formed in a form of predetermined pattern. Then a phosphor material is applied between the adjacent partition walls (23) and then calcined to form the phosphor layer (25). Next, a low-melting point frit glass material (namely, “sealing material to be used for panel sealing”) is applied onto a periphery of the substrate (20) and then calcined to form a sealing component (not shown in FIG. 1 (a)).

After the front and rear panels are obtained, so-called panel sealing step is performed. Specifically, the front panel (1) and rear panel (2) are disposed opposed to each other and then heated in their fixed state to soften the sealing component therebetween. Such sealing step enables the front panel and the rear panel to be air-tight bonded with each other by the sealing component. After the sealing step, the discharge space (30) is vacuumed while heating thereof, followed by a filling of the discharge space (30) with the discharge gas. In this way, PDP (100) is finally obtained.

### [Method of the Present Invention]

The method of the present invention particularly relates to a production of a front panel (more particularly a dielectric layer of the front panel) in the PDP production. The method of the present invention is characterized in that the content of an organic solvent contained in the dielectric material is suitably adjusted.

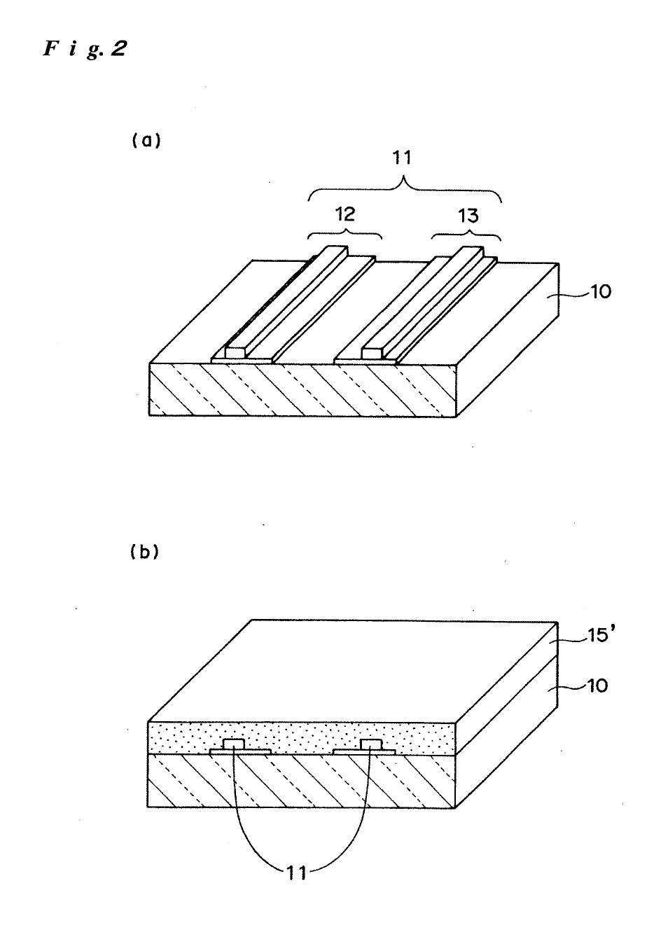

With reference to FIG. 2, some embodiments of the present invention will be described below. The present invention is carried out firstly by preparing a substrate and a dielectric material. Specifically, the substrate (10) having the electrodes (11) formed thereon as shown in FIG. 2(a) is prepared, and also the dielectric material is prepared as a step (i).

As used in this specification, the phrase “the substrate having the electrodes formed thereon” means the substrate having the front-sided electrodes formed thereon. For example, “the substrate having the electrodes formed thereon” is a glass substrate with a display electrode thereon. Namely, there is prepared a glass substrate (10) on which a display electrode (11) composed of a scan electrode (12) and a sustain electrode (13) is formed. The substrate (10) itself is preferably an insulating substrate made of soda-lime glass, high-strain point glass or various kinds of ceramics. It is preferred that the thickness of the substrate (10) is in the range of from about 1.0 mm to 3 mm. As each of the scan electrode (12) and the sustain electrode (13) of the display electrode (11), a transparent electrode made of ITO (about 50 nm to about 500 nm in thickness) (12a, 13a) is provided, and also a bus electrode made of silver (about 1 μm to about 10 μm in thickness) (12b, 13b) is provided on the transparent electrode to decrease the resistance value of the display electrode (see FIG. 1(b)). Specifically, the transparent electrode is formed by a thin film process, and subsequently the bus electrode is formed by a calcining process. Particularly upon the formation of the bus electrode, first, a conductive paste containing silver as a main component is supplied in a form of stripes by a screen printing process so as to form a bus electrode precursor. Alternatively, the bus electrode precursor may be formed in a form of stripes by patterning it using photolithography wherein a photosensitive paste which mainly contains silver is applied by a die coating process or a printing process, and then dried at 100° C. to 200° C., followed by exposure and developing thereof. Moreover, the bus electrode precursor may be formed by a dispensing process or an ink-jet process. The resulting bus electrode precursor is dried and then finally calcined at 400° C. to 600° C. to form a bus electrode therefrom.

As the dielectric material of the step (i), a paste material is prepared. The paste material mainly consists of a glass component and an organic solvent. Such paste is hereinafter also referred to as “dielectric material paste” or “dielectric paste material”.

The glass component of the dielectric material is preferably a component which contains a silicon compound, and more preferably a component which contains a compound with a siloxane bond (or siloxane backbone). The compound with a siloxane bond (or siloxane backbone) may be a low molecular weight to high molecular weight-compound with Si—O bond, and such compound may be an inorganic compound or an organic compound. Examples of the glass component include, but are not limited to, Si(OC₂H₅)₄ (TEOS: tetraethyl orthosilicate), methyltrimethoxysilane, methyltriethoxysilane, methyltriisopropoxysilane, ethyltrimethoxysilane, ethyltriethoxysilane, ethyltriisopropoxysilane, octyltrimethoxysilane, octyltriethoxysilane, vinyltrimethoxysilane, vinyltriethoxysilane, phenyltrimethoxysilane, phenyltriethoxysilane, trimethoxysilane, triethoxysilane, triisopropoxysilane, fluorotrimethoxysilane, fluorotriethoxysilane, dimethyldimethoxysilane, dimethyldiethoxysilane, diethyldimethoxysilane, diethyldiethoxysilane, dimethoxysilane, diethoxysilane, difluorodimethoxysilane, difluorodiethoxysilane, trifluoromethyltrimethoxysilane, trifluoromethyltriethoxysilane, silicon carbide (SiC), other alkoxide-based organic silicon compounds (Si(OR)₄), for example, tetratertiary butoxysilane (t-Si(OC₄H₉)₄) tetra secondary butoxysilane sec-Si(OC₄H₉)₄, tetratertiary amyloxysilane Si[OC(CH₃)₂C₂H₅]₄, and polymer compounds obtained by hydrolysis and condensation polymerization of these compounds.

Examples of the organic solvent of the dielectric material include, but are not limited to, alcohols such as methanol, ethanol, propanol, isopropyl alcohol, butanol and isobutyl alcohol; ketones such as methyl ethyl ketone and methyl isobutyl ketone (MIBK); terpenes such as α-terpineol, β-terpineol and γ-terpineol; ethylene glycol monoalkyl ethers; ethylene glycol dialkyl ethers; diethylene glycol monoalkyl ethers; diethylene glycol dialkyl ethers; ethylene glycol monoalkyl ether acetates; ethylene glycol dialkyl ether acetates; diethylene glycol monoalkyl ether acetates; diethylene glycol dialkyl ether acetates; propylene glycol monoalkyl ethers; propylene glycol dialkyl ethers; and propylene glycol monoalkyl ether acetates. These organic solvents can be used alone, but it is possible to suitably combine the above organic solvents with each other. Since it is desired that an organic solvent is vaporized by the heat treatment performed in the step (ii) of present invention, an organic solvent with a boiling point of about 300° C. or lower is preferably used, and an organic solvent with a boiling point of about 200° C. or lower is more preferably used.

Silica particles (glass component) may be added into the dielectric material paste in order to more effectively prevent the cracking of the dielectric layer. While there is not limited to the shape of the silica particles, mean particle size of the silica particles is preferably 400 nm or smaller, more preferably 100 nm or smaller and further more preferably 40 nm or smaller in order to ensure high transmissivity for visible light. The reason for this is that the wavelengths of the visible light are in a range of from 400 nm to 800 nm. When the mean particle size of the silica particles is 40 nm or less, such size is one tenth of the wavelength of the visible light or smaller, and falls within the Rayleigh scattering zone where the intensity of scattering the visible light significantly decreases, and is therefore preferable. The value of D90 (90th percentile value of particle size for accumulated volume) of the silica particles is preferably 400 nm or less, and more preferably the maximum particle size is 400 nm or less. The silica particles may not necessarily be of a single size, and thus may have two or more sizes. When the silica particles have two or more particle sizes, a packing density of the silica particles can be increased in the dielectric layer, and thus an occurrence of the cracking can be more effectively prevented. Amorphous silica particles are preferably used. The silica particles may be used as a dry powder. Alternatively, the silica particles may also be used as dispersed in water or organic solvent to form a sol state thereof. There is not limited to the surface condition and on the porosity of the silica particles. Thus, the silica particles that are commercially available may be used. The silica particles may be added either before or after preparing a sol-like dielectric material.

The dielectric material (preferably dielectric material paste) used in the method of the present invention may optionally comprise a binder resin in order to improve the property of the dielectric material paste to make it easier to apply. Examples of the binder resin include polyethylene glycol, polyvinyl alcohol, polyvinyl butyral, methacrylate ester polymer, acrylate ester polymer, acrylate ester-methacrylate ester copolymer, α-methylstyrene polymer, butyl methacrylate resin and cellulose-based resin. These binder resins can be used alone, but it is possible to suitably combine the above binder resins with each other. While the dielectric material paste undergoes weight loss due to evaporation of the organic solvent at a high temperature (e.g. temperature of from about 200° C. to about 400° C.), the rate of decreasing weight of the paste as a whole can be suppressed, and thus a stress attributable thereto can be suppressed by using the binder resin. In addition, the binder resin can serve to assist a bonding between the silica particles at higher temperatures.

The dielectric material consisting of the above components is preferably used in the form of a paste. It is thus preferred that the viscosity of the dielectric material is in the range of from about 1 mPa·s to about 50 Pa·s at the room temperature (i.e. 25° C.). When the viscosity of the dielectric material is within the above range, the undesirable spreading of the dielectric material can be effectively prevented upon an application thereof.

According to the present invention, the organic solvent content N contained in the dielectric material satisfies the following Inequality 1 (which will be described hereinafter in much more detail).

N<(6.5×Dz+500)/Ez (Inequality 1)
N [% by weight]: Content of organic solvent based on the weight of dielectric material
Ez [μm]: Thickness of electrode provided on substrate of front panel
Dz [μm]: Thickness of dielectric layer of front panel

Subsequent to the step (i), the step (ii) is performed. Specifically, the dielectric material is supplied onto the substrate whereon the electrodes have been formed, and the organic solvent contained in the dielectric material is diminished to form the dielectric precursor layer therefrom. More specifically, after applying the dielectric material onto a principal surface of the substrate (10) so as to cover the display electrodes (11), the dielectric material is heated to dry it, and thereby forming the dielectric precursor layer (15′) therefrom, as shown in FIG. 2(b).

The dielectric material can be applied by a dispensing process. In the dispensing process, a dielectric paste material is charged into a cylindrical vessel equipped with a small-diameter nozzle, and then the paste material is discharged therefrom by applying an air pressure to an aperture portion opposed to the nozzle. According to this dispensing process, the discharged amount of the paste material can be controlled by adjusting the air pressure and a pressurization time thereof.

Alternatively, the dielectric material can be applied by a die coating process. The die coating process is performed by discharging a paste material through a slit of a die head, while moving the die head or the substrate in the direction of an application. The die coating process is suitable for forming a thick film of the paste material. With respect to the present invention, the dielectric paste material is charged into a closed vessel (e.g. tank). The paste material is then supplied to a syringe pump from the vessel through a piping by pressurizing the inside of the vessel, followed by the supply of the paste material to the die head by mechanical force of the syringe pump. In order to stabilize the thickness of the applied film, a manifold is preferably disposed in the die head to make the paste material pressure attributable to the supplying force uniform along the direction of application width. Since an internal pressure until the dielectric paste material is discharged through the slit of the die head is not directly transmitted at the starting portion upon initiation of application, the thickness and shape of the film are controlled by partially adjusting the application rate. At the ending portion upon completion of the application, the thickness and shape of the film are controlled by stopping the supply of the paste material through the termination of the mechanical force of the syringe pump. Since the internal pressure of the paste material does not disappear immediately after the termination of mechanical force of the syringe pump, it is preferred that a piping valve for reducing the internal pressure is actuated and also the die head is moved upward immediately after the completion of the application so as to stabilize the film shape of the ending portion by cutting the paste with a shear stress thereof. Alternatively, a printing process, a photolithography process or the like may be employed for applying the dielectric paste material.

There is not limited to the thickness of the applied dielectric material (namely, a wet film thickness of dielectric material layer is not limited) as long as such thickness is commonly employed in the conventional PDP production process. And also there is not limited to the thickness of the dielectric precursor layer which is obtained by evaporating the organic solvent from the dielectric material as long as such thickness is commonly employed in the conventional PDP production process. For example, the wet film thickness of the dielectric material layer may be in a range of from about 10 μm to about 20 μm, whereas the thickness of the dielectric precursor layer may be in a range of from about 6 μm to about 15 μm. In this regard, the thickness of the dielectric precursor layer obtained after drying process is preferably 15 μm or less, which allows the effect of the present invention to be more effectively provided.

Reducing or diminishing of the organic solvent contained in the dielectric material requires an evaporation of the organic solvent. This may be done either by drying the applied dielectric material, or by placing the applied dielectric material under a reduced pressure or under a vacuum atmosphere. In a case where a drying process is employed for reducing the organic solvent, it is preferable to place the applied dielectric material at a drying temperature of about 50 to 200° C. under an atmospheric pressure for 0.1 to 2 hours. When the reduced pressure or vacuum atmosphere is employed, it is preferable to place the applied dielectric material under a reduced pressure or vacuum atmosphere of 7 to 0.1 Pa. As required, “reduced pressure or vacuum atmosphere” and “heat treatment” may be combined. In a case where the organic solvent is diminished by drying the dielectric material, the temperature rising rate T of the dielectric material upon heating thereof preferably satisfies the following Inequality 2.

T<(16×Dz+410−Ez×N)/(Dz+9) (Inequality 2)
T [° C./min]: Temperature rising rate of the supplied dielectric material upon heating thereof
N [% by weight]: Content of organic solvent based on the weight of dielectric material
Ez [μm]: Thickness of electrode provided on substrate of front panel
Dz [μm]: Thickness of dielectric layer of front panel

Subsequent to the step (ii), the step (iii) is performed. Namely, the dielectric precursor layer is subjected to heat treatment, and thereby a dielectric layer is formed from the dielectric precursor layer. In the step (iii), a condensation polymerization reaction proceeds in the dielectric precursor layer as the dielectric precursor layer is heated. Such condensation polymerization reaction eventually produces the dielectric layer (15). The heating temperature of the step (iii) is determined by the calorific value required for the condensation polymerization reaction and other factors such as the boiling point and content of the organic solvent that may still remain in the precursor layer. The heating temperature of the dielectric precursor layer is typically in the range of from about 500° C. to about 600° C. Similarly, the period of time during of which the dielectric material paste is subjected to the heat treatment is also determined by comprehensively considering the calorific value required for the condensation polymerization reaction and other factors such as the boiling point and content of the organic solvent that may still remain in the precursor layer. Such heating time of the dielectric precursor layer, which depends on the kind of the dielectric material, is typically in the range of from about 0.5 hour to about 2 hour. As a heat treatment means, a heating chamber (e.g. calcining furnace) may be used, for example. In this case, the dielectric precursor layer can be entirely heated by placing “substrate with the display electrode and the dielectric precursor layer formed thereon” obtained from the step (ii) within the heating chamber.

By performing the above steps (i) to (iii) as described above, a dielectric layer of a front panel can be finally obtained. This dielectric layer has substantially no cracking along the edges of the electrodes. Consequently, the PDP obtained through the production method of the present invention has an excellent insulation performance, allowing high definition display capability, and a panel lifetime is elongated. In other words, a dielectric breakdown phenomenon is prevented in the dielectric layer, and thereby a high definition of the PDP is achieved, which will lead to an improved panel lifetime.

The method of the present invention will be described below in much more detail. In particular, “Content N of organic solvent contained in dielectric material” and “Temperature rising rate T of dielectric material upon heating thereof” will now be described.

[symbol]

Organic solvent content N of dielectric material

[symbol]

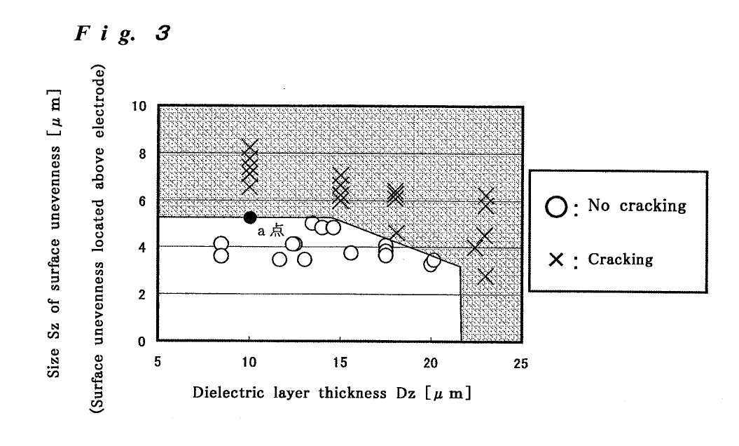

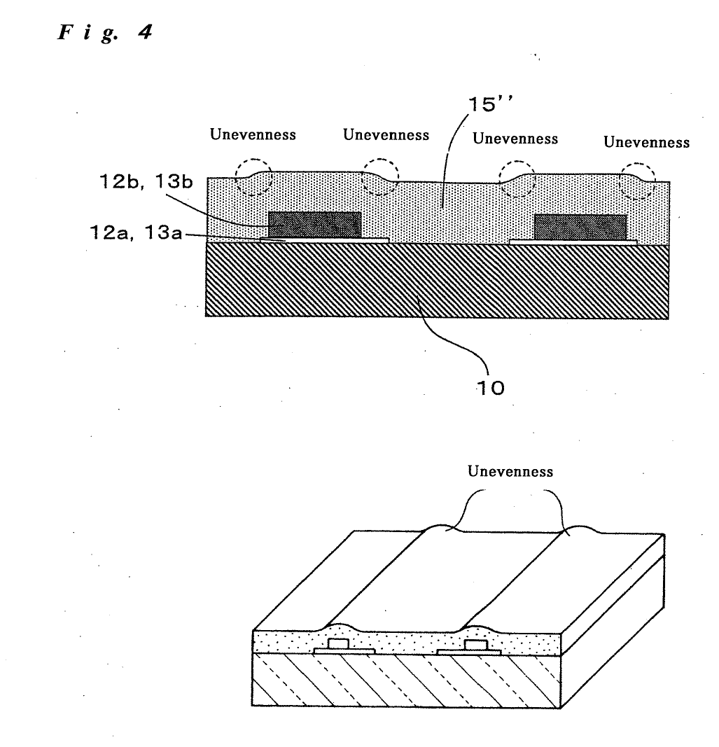

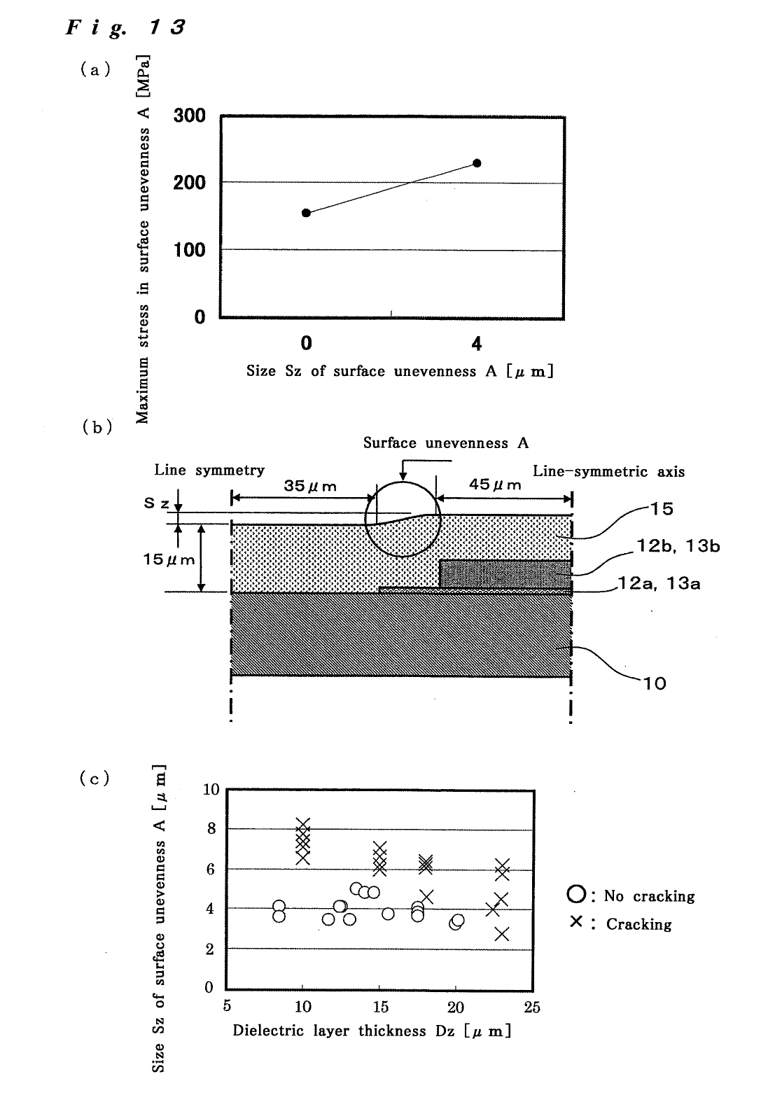

FIG. 3 is a graph showing the dependency of cracking on the thickness of the dielectric layer, the graph being obtained in Example to be described later. The graph of FIG. 3 indicates the correlation between the occurrence of cracking, the thickness of the dielectric layer and the surface unevenness. The phrase “surface unevenness” used herein refers to the surface irregularities of the dielectric layer (or the surface irregularities of the dielectric precursor layer) as shown in FIG. 4. Such surface unevenness is attributed mainly to the fact that there exists “electrode region” and “no-electrode region” in the surface of the substrate. As for the embodiment shown in FIG. 12, Sz represents the size of the surface unevenness. Mark “◯” in the graph of FIG. 3 indicates that the cracking did not occur in the dielectric layer. While on the other hand, Mark “X” indicates that the cracking did occur in the dielectric layer.

With reference to “point a” shown in the graph of FIG. 3, a more detailed explanation will be given below: In a case where the dielectric layer has the thickness of point a (namely, the dielectric layer thickness is about 10 μm), the physical defects such as cracking tend to occur when the size of the surface unevenness is larger than about 5 μm. While on the other hand, such physical defects are less likely to occur when the size of the surface unevenness is smaller than about 5 μm. In other words, the cracking is likely to occur in the shaded region shown in the graph of FIG. 3.

In an ordinary PDP production process (particularly PDP production process employing the sol-gel technique for forming the dielectric layer), the dielectric layer typically has a thickness of 15 μm or less. In other words, it is typical that the thickness of the dielectric layer is 15 μm or less. Considering this requirement of the dielectric layer thickness, it can be understood, based on the graph of FIG. 3 that the surface unevenness must be less than about 5 μm in order to effectively prevent the occurrence of the cracking.

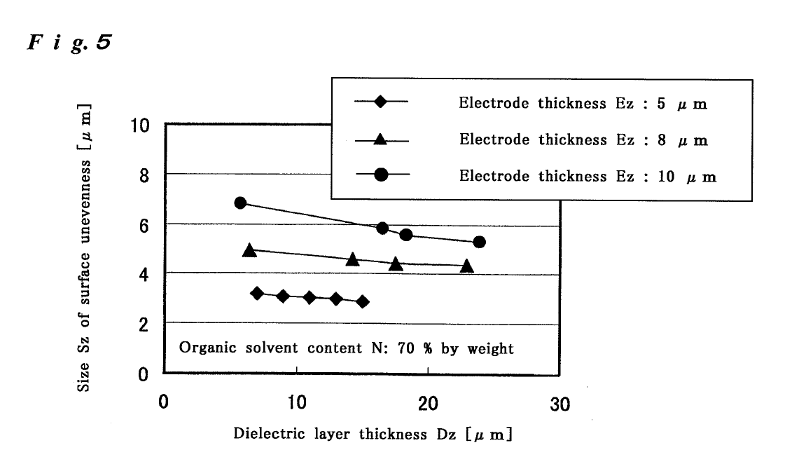

FIG. 5 is a graph showing the correlation between the dielectric layer thickness and the surface unevenness, the graph being obtained in Example to be described later. Specifically, the graph of FIG. 5 shows the correlation between the thickness Dz of the dielectric layer and the size Sz of the surface unevenness for various values of electrode thickness Ez under such a condition that the dielectric layer is formed by using a dielectric material paste with the organic solvent content of 70% by weight. It can be seen from the graph of FIG. 5 that the size Sz of the surface unevenness decreases as the thickness Dz of the dielectric layer increases. In other words, it can be seen from the graph of FIG. 5 that the size Sz of the surface unevenness depends on the thickness Dz of the dielectric layer.

The surface unevenness size Sz (μm) of the dielectric layer can be expressed by the following equation 3 with an electrode thickness Ez (μm), an organic solvent content N (% by weight) of the dielectric material paste and a factor F(Dz) which is a function of the thickness Dz (μm) of the dielectric layer:

Sz=(Ez×N/100)×(1/F(Dz)) Equation 3

A detailed explanation about the equation 3 will now be described: The first term (Ez×N/100) on the right side of the equation 3 represents the effective size of the surface unevenness, and the second term (1/F(Dz)) on the right side is the coefficient thereof. This means that the effective size of the surface unevenness is given by “(Ez×N/100)” wherein it depends on the thickness Dz of the dielectric layer by a factor of (1/F(Dz)). It should be noted that the dependency of the unevenness size on the dielectric layer thickness is based on the result shown in FIG. 5.

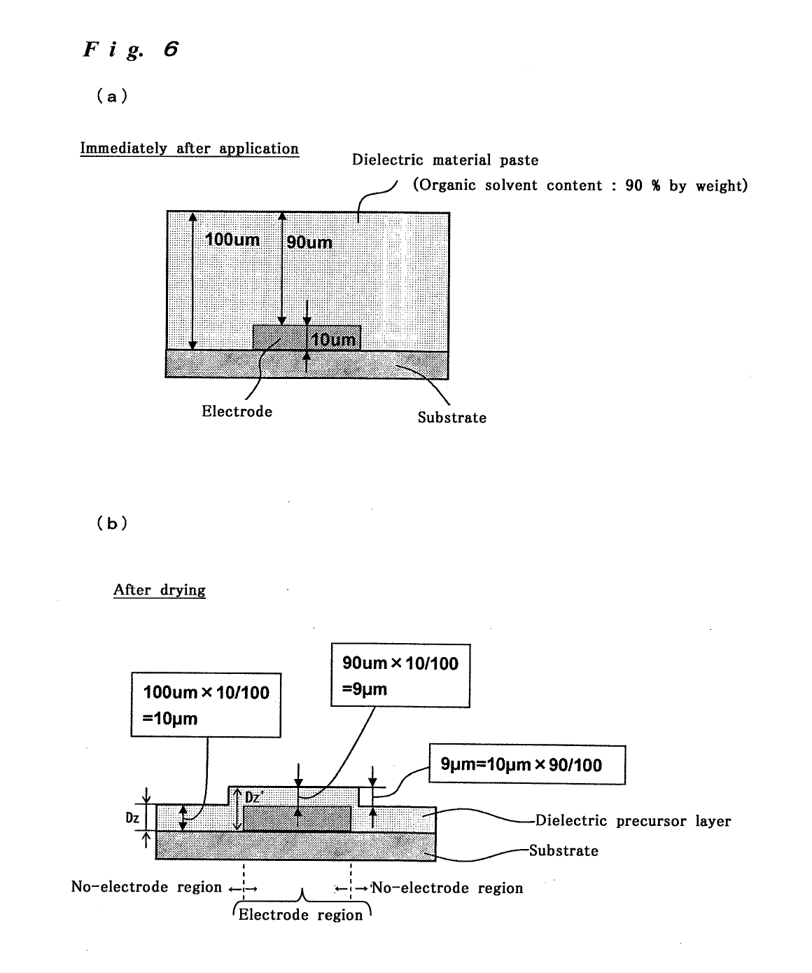

With respect to the effective size (Ez×N/100) of the surface unevenness, a more detailed explanation will now be described: An assumption for the explanation is that, as shown in FIG. 6(a), the dielectric material paste having an organic solvent content of 90% by weight has been applied with uniform thickness of 100 μm onto the substrate having the electrode formed thereon with electrode's thickness of 10 μm. In this case, solid content of the dielectric material paste is 10% by weight (=“100−90” % by weight). Therefore, when the organic solvent is completely evaporated by drying the dielectric material paste, a dielectric precursor layer with a thickness of 10 μm (=100 μm× 10/100) is formed in a no-electrode region due to the existence of the 100 μm-thick dielectric material paste therein, as shown in FIG. 6(b). While on the other hand, a dielectric precursor layer with a thickness of 9 μm (=90 μm× 10/100) is formed in an electrode region due to the existence of the 90 μm-thick dielectric material paste therein after a complete evaporation of the organic solvent. Accordingly, the distance Dz′ between the substrate surface and the surface of the dielectric precursor layer in the electrode region is 19 μm (=“10+9” μm), whereas the distance Dz between the substrate surface and the surface of the dielectric precursor layer in the no-electrode region is 10 μm. Thus, it turns out that the unevenness size Sz (=Dz′−Dz) is 9 μm wherein “9 μm” corresponds to the product of the electrode thickness of 10 μm and a proportion 0.9 of the organic solvent content (i.e. 9 μm=10 μm×0.9). These explanations will lead to better understanding that the effective size Sz of the surface unevenness is given by Sz=Ez×N/100.

Alternatively, the following matter will also lead to understanding of Sz=Ez×N/100:

When the consideration is given to the facts that Dz=(wet thickness)×(100−N)/100 and Dz′=(wet thickness−Ez)×(100−N)/100+Ez, then it follows that Sz=Dz′−Dz=[(wet thickness−Ez)×(100−N)/100+Ez]−(wet thickness)×(100−N)/100=Ez×N/100

Transformation of the equation 3 results in the following:

F(Dz)=(Ez×N/100)/Sz

The electrode thickness Ez, the organic solvent content N and the unevenness size Sz have all been obtained as experimental values from FIG. 5. Thus F(Dz) is obtained by putting the values of Ez, N and Sz into the equation 3 for each point plotted in FIG. 5. In this regard, FIG. 7 is a graph obtained by plotting the values of F(Dz) against Dz of abscissa through putting the values of Ez, N and Sz of FIG. 5 into the equation 3. Approximation of such plots results in linear equation y=0.013x+1.0. Thus, it follows that the function F(Dz) can be expressed by the equation 4.

F(Dz)=0.013×Dz+1.0 Equation 4

In order to prevent the occurrence of the cracking, the surface unevenness must be smaller than 5 μm as described above. In other words, the occurrence of the cracking can be prevented when the following inequality 5 is satisfied:

Sz<5 Inequality 5

Thus combining the equation 3, the equation 4 and the inequality 5 into one relationship and transforming it for N results in the following inequality 1.

N<(6.5×Dz+500)/Ez Inequality 1
N [% by weight]: Content of organic solvent based on the weight of dielectric material
Ez [μm]: Thickness of electrode provided on substrate of front panel (=Thickness of transparent electrode+Thickness of bus electrode)
Dz [μm]: Thickness of dielectric layer of front panel (=Thickness of the dielectric layer provided on the no-electrode region)

The inequality 1 includes the requirement of the inequality 5 for the effect of cracking prevention (i.e. the requirement of the surface unevenness size being less than 5 μm). Therefore, when the organic solvent content N (%) by weight) of the dielectric material is less than “(6.5×Dz+500)/Ez”, then the surface unevenness of the resultant dielectric layer can be smaller so that the occurrence of the cracking is effectively prevented or suppressed.

For example, in a case where the electrode thickness Ez is about 7 μm and the thickness Dz of the dielectric layer is about 10 to 15 μm, the inequality 1 indicates that the organic solvent content of the dielectric material used for a formation of the dielectric layer should be less than about 85% by weight. In a case where the electrode thickness Ez is about 8 μm and the thickness Dz of the dielectric layer is about 10 to 15 μm, the organic solvent content of the dielectric material used for a formation of the dielectric layer should be less than about 75% by weight. Meanwhile the lower limit of the organic solvent content of the dielectric material is about 30% by weight lest an aggregation or gelation of the dielectric material should result in a decrease of pot life and/or the loss of uniformity of the dielectric layer.

[symbol]

Temperature Rising Rate T of Dielectric Material Upon Heating thereof for Drying

[symbol]

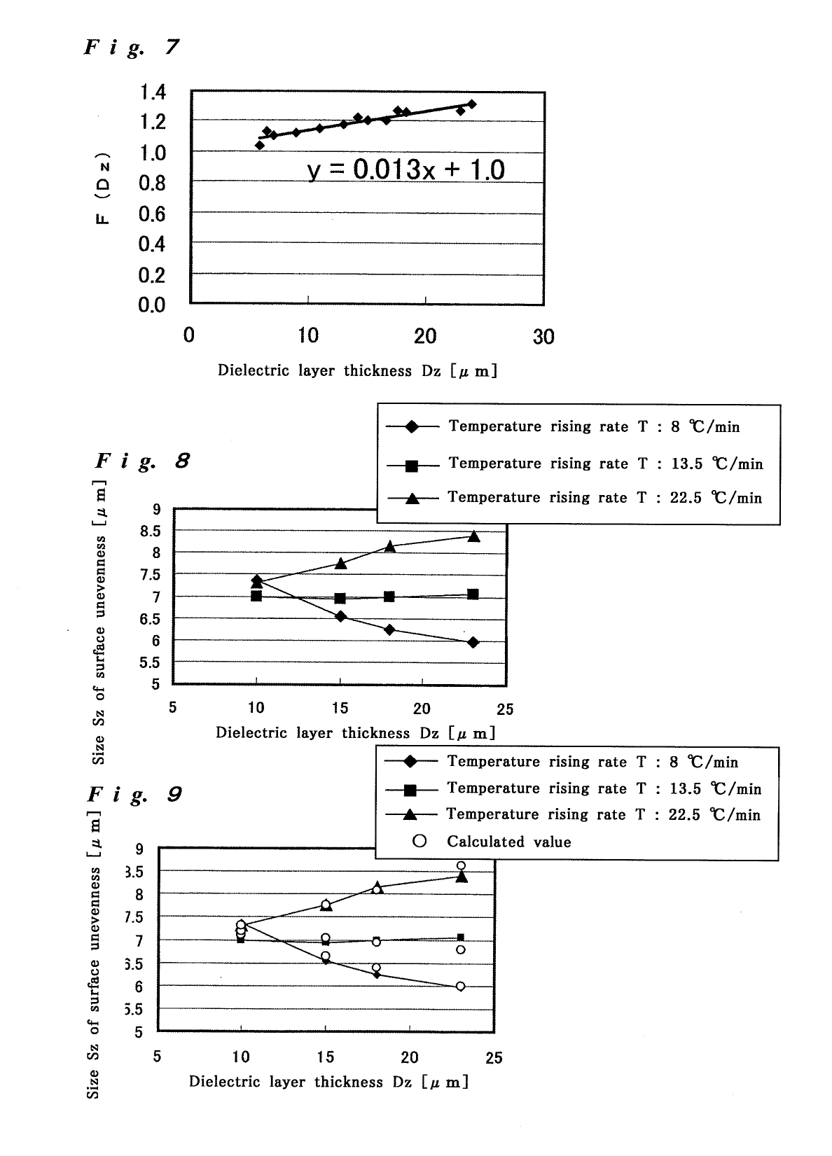

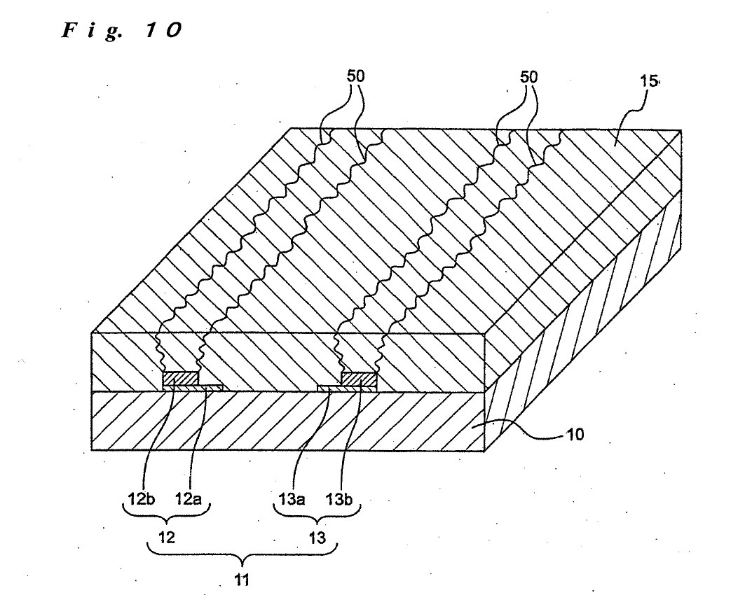

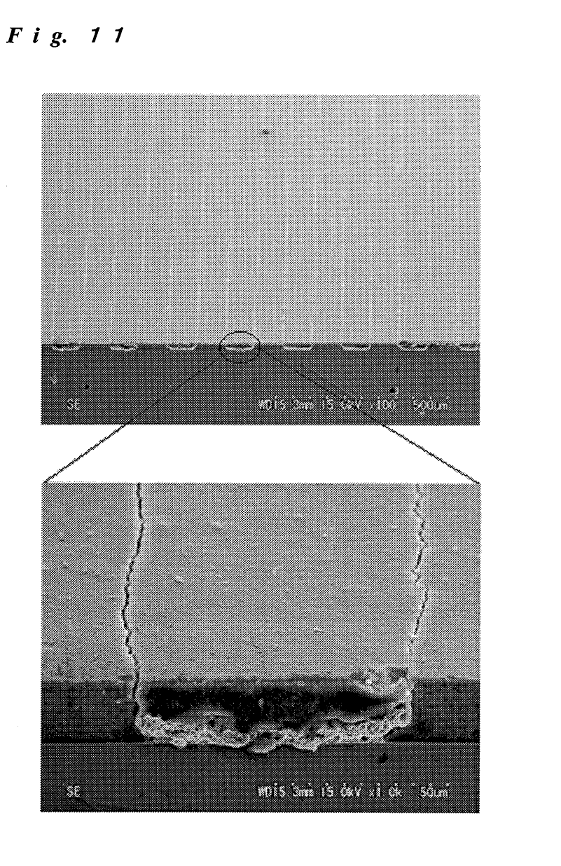

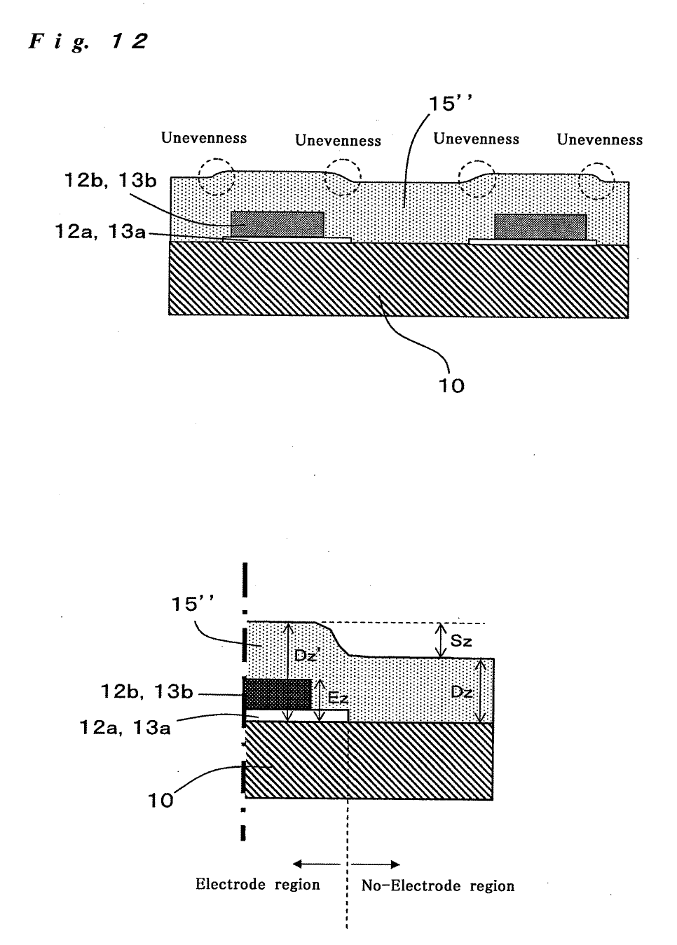

FIG. 8 is a graph showing the correlation between the temperature rising rate, the surface unevenness and the dielectric layer thickness, the graph being obtained in Example to be described later. Specifically, the graph of FIG. 8 indicates the relation between the dielectric layer thickness Dz and the surface unevenness Sz for various values of temperature rising rate T regarding the dielectric material, when forming the dielectric layer on the substrate surface having about 6-μm thick electrode thereon. As used in this specification and claims, the phrase “temperature rising rate” means a heating rate upon drying the applied dielectric material paste, and thereby forming the dielectric precursor layer therefrom. With reference to FIG. 8, it can be understood that the size Sz of the surface unevenness depends not only on the thickness Dz of the dielectric layer but also on the temperature rising rate T. For example, the following facts prove that the size Sz of the surface unevenness depends on the dielectric layer thickness Dz and the temperature rising rate T.
When the temperature rising rate T is 8° C./min, the size Sz of the surface unevenness becomes smaller as the thickness Dz of the dielectric layer becomes larger;
When the temperature rising rate T is 13.5° C./min, the size Sz of the surface unevenness remains almost constant regardless of the values of the thickness Dz of the dielectric layer; and
When the temperature rising rate T is 22.5° C./min, the size Sz of the surface unevenness becomes larger as the thickness Dz of the dielectric layer becomes larger.

The size Sz of the surface unevenness can be expressed by the following equation 6 in terms of the electrode thickness Ez (μm), the organic solvent content N (% by weight) of the dielectric material paste and coefficient Γ(Dz, T) that is a function of the thickness Dz (μm) of the dielectric layer and the temperature rising rate T (° C./min.):

Sz=(Ez×N/100)×(1/F(Dz,T)) Equation 6

A detailed explanation about the equation 6 will now be described: The first term (Ez×N/100) on the right side of equation 6 represents the effective size of the surface unevenness, and the second term (1/F(Dz, T)) on the right side is the coefficient thereof. This means that the effective size of the surface unevenness is given by “(Ez×N/100)” wherein it depends on the thickness Dz of the dielectric layer and the temperature rising rate T by a factor of (1/F(Dz, T)). It should be noted that the dependency of the unevenness size on the dielectric layer thickness Dz and the temperature rising rate T is based on the result shown in FIG. 8. As for the effective unevenness size (Ez×N/100), a detailed explanation has been already given above in “Organic solvent content N of dielectric material”, and will not be described here to avoid duplication.

Transformation of the equation 6 results in the following equation 7:

F(Dz,T)=(Ez×N/100)/Sz Equation 7

The equation 7 can be mathematically modeled by the following equation 8:

F(Dz,T)=a(T)×Dz+b(T) Equation 8

A(T)=c×T+d Equation 9

B(T)=e×T+f Equation 10

Rationale for the equation 8 will be described.

The equation 8 is mathematically modeled similarly to the equation 4. In this regard, the equation 4 expresses the factor F(Dz) of the coefficient (1/F(Dz)) for the uneveness size (Ez×N/100) as a linear function. Since it can be seen from FIG. 8 that the unevenness size (Ez×N/100) depends not only on the dielectric layer thickness Dz but also on the temperature rising rate T, the equation 4 is expanded into the equation 8 by incorporating the factor of the temperature rising rate T (i.e. effect of the temperature rising rate) thereinto. In other words, the equation 8 is mathematically modeled on the basis of the equation 4, by taking it into account that “gradient” and “intercept of ordinate axis (=y−intercept)” regarding the graph of the equation 4 depend on the temperature rising rate T.

In this case, the following inequality 2 can be derived by substituting c=−0.002, d=0.032, e=0.018 and f=0.82 into the equations 9 and 10, and combining the inequality 5, the equations 6 and 8 into one relationship and transforming it for the temperature rising rate T:

T<(16×Dz+410−Ez×N)/(Dz+9) Inequality 2
T [° C./min]: Temperature rising rate of the supplied dielectric material upon heating thereof (=temperature rising rate of heating treatment to be performed in the step (ii))
N [% by weight]: Content of organic solvent based on the weight of dielectric material
Ez [μm]: Thickness of electrode provided on substrate of front panel (=Thickness of transparent electrode+Thickness of bus electrode)
Dz [μm]: Thickness of dielectric layer of front panel (=Thickness of the dielectric layer provided on the no-electrode region)

The values calculated with the inequality 2 and the experimental values shown in FIG. 8 are fairly coincident with each other as shown in FIG. 9. Accordingly, it will be understood that the inequality 2 appropriately reflects the results of FIG. 8. In other words, an inductive analysis of the results of FIG. 8 leads to the inequality 2 which expresses a general formula defining the temperature rising rate T.

The relation of inequality 2 includes the requirement of the inequality 5 for the effect of the cracking prevention (i.e. the requirement of the surface unevenness size being less than 5 μm). Therefore, when the temperature rising rate T upon heating the dielectric material for drying thereof is less than “(16×Dz+410-Ez×N)/(Dz 9)”, then the surface unevenness of the resultant dielectric layer can be smaller so that the occurrence of the cracking is effectively prevented or suppressed.

As for a typical PDP, the thickness Ez of the electrode is about 4 to 8 μm and the thickness Dz of the dielectric layer is about 10 to 15 μm, for example. Therefore, the inequality 2 suggests that the preferable temperature rising rate T (° C./min) is as follows:
(Case 1) Ez=4 μm, Dz=10 to 15 μm, organic solvent content N=70% by weight →T<15.18
(Case 2) Ez=5 μm, Dz=10 to 15 μm, organic solvent content N=70% by weight→T<11.06
(Case 3) Ez=6 μm, Dz=10 to 15 μm, organic solvent content N=70% by weight →T<7.89
(Case 4) Ez=7 μm, Dz=10 to 15 μm, organic solvent content N=70% by weight→T<4.21
(Case 5) Ez=8 μm, Dz=10 to 15 μm, organic solvent content N=70% by weight →T<0.53

Meanwhile, the lower limit of the temperature rising rate T of the dielectric material upon heating thereof for drying is about 0.1 (° C./min).

The present invention has been hereinabove described with reference to preferred embodiments. It will be however understood by those skilled in the art that the present invention is not limited to such embodiments and can be modified in various ways.

For example, according to the above embodiment, the precursor layer, which is obtained in the step (ii) by drying the dielectric material to reduce the organic solvent contained therein, is subjected to a heat treatment so as to undergo a condensation polymerization reaction in the step (iii). The present invention, however, is not limited to this embodiment. The condensation polymerization reaction may partially start or proceed upon the drying treatment of the dielectric material in the step (ii). Even in this case, a substantial effect of the present invention is similarly provided, so that the cracking phenomenon is effectively prevented or reduced. Moreover, while the organic solvent of the dielectric material paste is evaporated in the step (ii), it is not necessary to evaporate all the organic solvent in the step (ii). Some amount of the organic solvent may still remain in the dielectric material as long as the desired dielectric precursor layer can be provided.

### Examples

### Production Method of the Present Invention

As an example, the dielectric layer was formed by using a dielectric material paste with the inequality 1 satisfied, and then characteristic thereof was studied.

### (Dielectric Material Paste)

Dielectric material paste A with the following composition and physical properties was used for forming a dielectric layer.
Glass component: Polysiloxane oligomer obtained from TEOS and the like, and spherical silica particles with a diameter of from about 50 to 200 nm
Organic solvent component (about 70% by weight): Isopropyl alcohol, α-terpineol
Viscosity of paste A: About 50 mPa·s (25° C.)

### (Production of Front Panel)

First, a transparent electrode made of ITO (0.12 mm in width and 100 nm in thickness of the transparent electrode) was formed on a surface of 1.8 mm-thick glass substrate (i.e. soda-lime glass, manufactured by Nippon Electric Glass Co., Ltd.) and subsequently a bus electrode made of Ag (0.065 mm in width and 6 μm in thickness of the bus electrode) was formed on the transparent electrode. Next, the dielectric material paste A was entirely applied onto the glass substrate by a die coating process to form a dielectric material layer. Subsequently, the dielectric material layer was dried at 100° C. (under a temperature rising rate condition of 20° C./min) to form a dielectric precursor layer. The dielectric precursor layer was then heated at 500° C., and thereby allowing the condensation polymerization reaction of a polysiloxane oligomer to proceed in the dielectric precursor layer to form a dielectric layer with a thickness of 0.015 mm. Finally, as a protective layer, a film made of MgO was formed on the dielectric layer by an electron-beam evaporation process, and thereby completing the production of the front panel.

### (Characteristics of Dielectric Layer)

Characteristics and specification of the dielectric layer thus formed were as follows:
Dielectric constant: 3.0 at 100 kHz (Meter Model KC-555 manufactured by Kokuyo Electric Co., Ltd.)
Light transmittance: 81% (Haze meter HM-150 manufactured by MURAKAMI COLOR RESEARCH LABORATORY CO., Ltd.)
Surface unevenness size: 3.5 μm
Physical defect: No cracking along electrode was observed with an electron microscope and a optical microscope.

From the results of the Example described above, it can be understood that the use of the dielectric material paste satisfying the inequality 1 makes it possible to effectively prevent the occurrence of the cracking in the dielectric layer. <<Graphs of FIG. 3, FIG. 5 and FIG. 8>>

The graphs of FIGS. 3, 5 and 8 used for deriving the inequality 1 and inequality 2 were respectively obtained through the following formation of the dielectric layer, such formation being similar to that described above.

### (Graph of FIG. 3)

A transparent electrode made of ITO (0.12 mm in width and 100 nm in thickness of the transparent electrode) was formed on a surface of 1.8 mm-thick glass substrate (i.e. soda-lime glass, manufactured by Nippon Electric Glass Co., Ltd.) and subsequently a bus electrode made of Ag (0.065 mm in width and 6 μm in thickness of the bus electrode) was formed on the transparent electrode. Next, the dielectric material paste A was entirely applied onto the glass substrate by a die coating process to form a dielectric material layer. Subsequently, the dielectric material layer was dried at 100° C. (under a temperature rising rate condition of 20° C./min) to form a dielectric precursor layer. The dielectric precursor layer was then heated at 500° C., and thereby allowing the condensation polymerization reaction of a polysiloxane oligomer to proceed in the dielectric precursor layer. As a result, a dielectric layer with a thickness of 0.015 mm was formed, covering the electrodes. Particularly with respect to the graph of FIG. 3, the various dielectric layers ware formed by employing the different values of the dielectric layer thickness Dz, while measuring the surface unevenness size Sz (μm) and observing to see whether or not the cracking occurs with an electron microscope and an optical microscope.

### (Graph of FIG. 5)

A transparent electrode made of ITO was formed on a surface of 1.8 mm-thick glass substrate (i.e. soda-lime glass, manufactured by Nippon Electric Glass Co., Ltd.) and subsequently a bus electrode made of Ag was formed on the transparent electrode. Next, the dielectric material paste A was entirely applied onto the glass substrate by a die coating process to form a dielectric material layer. Subsequently, the dielectric material layer was dried at 100° C. (under a temperature rising rate condition of 20° C./min) to form a dielectric precursor layer. The dielectric precursor layer was then heated at 500° C., and thereby allowing the condensation polymerization reaction of a polysiloxane oligomer to proceed in the dielectric precursor layer. As a result, a dielectric layer with a thickness of 0.015 mm was formed, covering the electrodes. Particularly with respect to the graph of FIG. 5, the various dielectric layers ware formed by employing the different values of the dielectric layer thickness Dz for three values of electrode thickness (5 μm, 8 μm and 10 μm), while measuring the surface unevenness size Sz (μm).

### (Graph of FIG. 8)

A transparent electrode made of ITO (0.12 mm in width and 100 nm in thickness of the transparent electrode) was formed on a surface of 1.8 mm-thick glass substrate (i.e. soda-lime glass, manufactured by Nippon Electric Glass Co., Ltd.) and subsequently a bus electrode made of Ag (0.065 mm in width and 6 μm in thickness of the bus electrode) was formed on the transparent electrode. Next, the dielectric material paste A was entirely applied onto the glass substrate by a die coating process to form a dielectric material layer. Subsequently, the dielectric material layer was dried at 100° C. to form a dielectric precursor layer. The dielectric precursor layer was then heated at 500° C., and thereby allowing the condensation polymerization reaction of a polysiloxane oligomer to proceed in the dielectric precursor layer. As a result, a dielectric layer with a thickness of 0.015 mm was formed, covering the electrodes. Particularly with respect to the graph of FIG. 8, the various dielectric layers ware formed by employing the different values of the dielectric layer thickness Dz for three values of the temperature rising rate (8° C./min, 13.5° C./min and 22.5° C./min), while measuring the surface unevenness size Sz (μm).

### INDUSTRIAL APPLICABILITY

The PDP obtained by the method of the present invention has low power consumption, and thus it is not only suitable for household use and commercial use, but also suitable for use in other various kinds of display devices.

### CROSS REFERENCE TO RELATED PATENT APPLICATION

The disclosure of Japanese Patent Application No. 2009-073610 filed Mar. 25, 2009 including specification, drawings and claims is incorporated herein by reference in its entirety.

1. A method for producing a plasma display panel comprising a front panel wherein an electrode, a dielectric layer and a protective layer are formed on a substrate of the front panel,
a formation of the dielectric layer comprising:
(i) preparing a dielectric material comprising a glass component and an organic solvent;
(ii) supplying the dielectric material onto the substrate having the electrode thereon, and then reducing the organic solvent contained in the supplied dielectric material to form a dielectric precursor layer therefrom; and
(iii) heating the dielectric precursor layer to form a dielectric layer therefrom,
wherein content N of the organic solvent contained in the dielectric material of the above (i) satisfies
N<(6.5×Dz+500)/Ez
where N [% by weight] is a content of organic solvent based on the weight of the dielectric material;
Ez [μm] is a thickness of the electrode provided on the substrate of the front panel; and
Dz [μm] is a thickness of the dielectric layer of the front panel.

2. The method according to claim 1, wherein
in step (ii), the organic solvent is reduced by heating the supplied dielectric material; and
a temperature rising rate T of the dielectric material upon heating thereof satisfies
T<(16×Dz+410−Ez×N)/(Dz+9) Inequality 2
where T [° C./min] is the temperature rising rate of the supplied dielectric material upon heating thereof;
N [% by weight] is the content of the organic solvent based on the weight of the dielectric material;
Ez [μm] is the thickness of the electrode provided on the substrate of the front panel; and
Dz [μm] is the thickness of the dielectric layer of the front panel.
